(19) United States
(12) Patent Application Publication
(10) Pub. No.: US 2003/0187911 A1
(43) Pub. Date: Oct. 2, 2003

(54) Method and apparatus to facilitate recovering a thread from a checkpoint

(76) Inventors: Michael Abd-El-Malek, Windsor (CA); Bernd J.W. Mathiske, Cupertino, CA (US)

Correspondence Address: PARK, VAUGHAN & FLEMING LLP, 508 SECOND STREET, SUITE 201, DAVIS, CA, 95616, US

(21) Appl. No.: 10/113,501

(22) Filed: Apr. 1, 2002

(51) Int. Cl. G06F 9/00

(52) U.S. Cl. 709/108

(57) ABSTRACT

One embodiment of the present invention provides a system that facilitates recovering a thread from a checkpoint. During operation, the system receives an invocation of a program method at an interpreter. The interpreter determines if the interpreter is operating in restoration mode. If so, the interpreter initializes a stack for the current thread. Next, the interpreter creates a stack frame for the program method, and restores local values and parameters into the stack frame from the checkpoint. The interpreter also restores a bytecode index for the method to identify a bytecode that is currently being executed within the method. Note that the present invention can save a significant amount of programmer time by making use of an existing thread-creation framework within an interpreter to perform thread recovery functions for checkpointing purposes.

### BACKGROUND

1. Field of the Invention

The present invention relates to providing fault-tolerance in computer systems. More specifically, the present invention relates to a method and an apparatus for recovering a computer program from a checkpoint.

2. Related Art

Computer systems often provide a checkpointing mechanism for fault-tolerance purposes. A checkpointing mechanism operates by periodically storing a snapshot of the state of a running computer system to a checkpoint repository, such as a checkpoint file. If the computer system subsequently fails, the computer system can rollback to a previous checkpoint by using information from the checkpoint file to recreate the state of the computer system at the time of the checkpoint. This allows the computer system to resume execution from the checkpoint, without having to redo the computational operations performed prior to the checkpoint.

In order to checkpoint a process (which possibly includes multiple threads), it is necessary to record thread-specific information, so that the threads can be accurately recreated during a checkpoint recovery operation. In particular, thread stacks must be accurately recreated. Otherwise, the restored program may behave differently than the original program.

Note that native threads within an operating system are often referred to as “light-weight processes” (LWPs). LWPs are typically created and scheduled by the operating system, and the operating system typically provides only a minimal application program interface (API) to manipulate LWPs from outside the operating system kernel. The abstraction of an LWP through an API is often referred to as a “thread”. Within this specification, we refer to both an “LWP” and an abstraction of the LWP through an API as a “thread”.

While restoring the thread stacks is relatively straightforward when the program is restored on the same architecture and at the same address where the program was originally executing, recovering thread stacks on a different architecture or at a different address can result in extensive programming effort. For example, a different architecture may grow the stack in a different direction than the original architecture.

What is needed is a method and an apparatus that facilitates recovering a thread from a checkpoint without the problems listed above.

### SUMMARY

One embodiment of the present invention provides a system that facilitates recovering a thread from a checkpoint. During operation, the system receives an invocation of a program method at an interpreter. The interpreter determines if the interpreter is operating in restoration mode. If so, the interpreter initializes a stack for the current thread. Next, the interpreter creates a stack frame for the program method, and restores local values and parameters into the stack frame from the checkpoint. The interpreter also restores a bytecode index for the method to identify a bytecode that is currently being executed within the method. Note that the present invention can save a significant amount of programmer time by making use of an existing thread-creation framework within an interpreter to perform thread recovery functions for checkpointing purposes.

In one embodiment of the present invention, the system repeats the steps of creating the stack frame, restoring local values, restoring parameters, and restoring the bytecode index for each nested method until the last nested method for the current thread is recovered.

In one embodiment of the present invention, the system repeats the steps of initiating an additional stack for the next thread, creating the stack frame, restoring local values, restoring parameters, and restoring the bytecode index for each thread until the last thread for a current program is recovered.

In one embodiment of the present invention, the system delays execution of the current thread until the last thread of the current program is recovered.

In one embodiment of the present invention, restoring local values and restoring parameters includes adjusting pointer references to point to updated locations for restored objects.

In one embodiment of the present invention, the program method can be restored on computer architecture that is different from a computer architecture where the program method was originally executing.

### BRIEF DESCRIPTION OF THE FIGURES

FIG. 1 illustrates the process of creating a checkpoint in accordance with an embodiment of the present invention.

FIG. 2 illustrates the process of restoring a checkpoint in accordance with an embodiment of the present invention.

FIG. 3 illustrates the structure of an interpreter in accordance with an embodiment of the present invention.

FIG. 4 illustrates the state of a program thread in accordance with an embodiment of the present invention.

FIG. 5 is a flowchart illustrating the process of recovering a from checkpoint in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Creating a Checkpoint

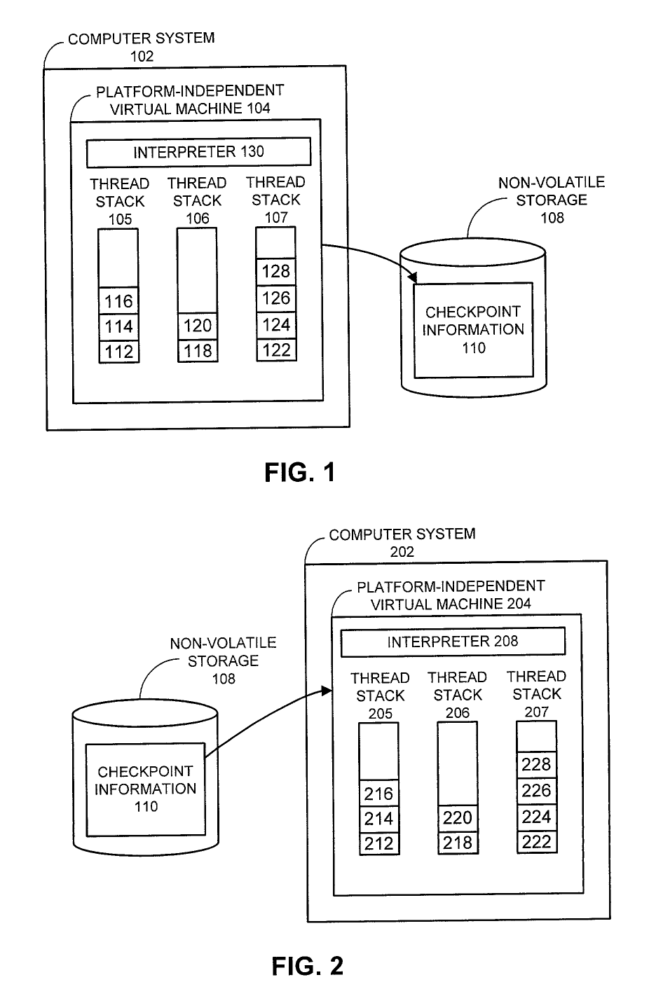

FIG. 1 illustrates the process of creating a checkpoint in accordance with an embodiment of the present invention. In FIG. 1, computer system 102 executes platform-independent virtual machine 104. Computer system 102 can generally include any type of computer system, including, but not limited to, a computer system based on a microprocessor, a mainframe computer, a digital signal processor, a portable computing device, a personal organizer, a device controller, and a computational engine within an appliance.

Platform-independent virtual machine 104 is a program that executes platform-independent code. For example, platform-independent virtual machine 104 can include the JAVA VIRTUAL MACHINE (JVM), which executes JAVA bytecodes. (The terms JAVA, JVM, and JAVA VIRTUAL MACHINE are trademarks or registered trademarks of SUN Microsystems, Inc. of Palo Alto, Calif.)

Platform-independent virtual machine 104 includes interpreter 130 and thread stacks 105, 106, and 107. Platform-independent virtual machine 104 may also include classes, bytecodes, heaps, and a just-in-time compiler, which are not shown. Within this specification and associated claims, the term “bytecodes” refers to the platform-independent codes that are executed on a platform-independent virtual machine. Thread stacks 105, 106, and 107 are associated with threads of execution for a program executing on platform-independent virtual machine 104.

Each thread stack is associated with a number of stack frames. In particular, thread stack 105 includes stack frames 112, 114, and 116; thread stack 106 includes stack frames 118 and 120; and thread stack 107 includes stack frames 122, 124, 126, and 128. Stack frames 112-128 contain local variables and parameters as well as other information for methods executing on related threads.

Periodically, platform-independent virtual machine 104 creates a checkpoint of the executing program for fault-tolerance purposes. In the event of a system failure, this checkpoint can be used to restart the program from the checkpoint on computer system 102 or on a different computer system. Note that platform-independent virtual machine 104 stores checkpoint information 110 in non-volatile storage 108.

Non-volatile storage 108 can include any type of non-volatile storage device that can be coupled to a computer system. This includes, but is not limited to, magnetic, optical, and magneto-optical storage devices, as well as storage devices based on flash memory and/or battery-backed up memory.

Checkpoint information 110 includes identifiers for thread stacks 105, 106, and 107 and information related to stack frames 112-128. For each stack frame, checkpoint information 110 includes information specifying how to reconstruct the stack frame. For example, checkpoint information 110 can include a count of the local variables, a count of the parameters, and the values for the local variables and parameters for stack frame 112. Checkpoint information 110 also includes information designating the local variables and parameters as values or pointers.

Restoring a Program from Checkpoint

FIG. 2 illustrates the process of restoring a program from a checkpoint in accordance with an embodiment of the present invention. In FIG. 2, computer system 202 executes platform-independent virtual machine 204. Note that computer system 202 can generally include any type of computer system, including, but not limited to, a computer system based on a microprocessor, a mainframe computer, a digital signal processor, a portable computing device, a personal organizer, a device controller, and a computational engine within an appliance. Also note that it is not necessary for computer system 202 to have the same architecture as computer system 102.

Platform-independent virtual machine 104 includes interpreter 208, which can execute platform-independent code. In addition to standard interpreter features, interpreter 208 includes facilities to restore programs from a checkpoint using checkpoint information such as checkpoint information 110. Recall that checkpoint information 110 stored in non-volatile storage 108 as was described with reference to FIG. 1.

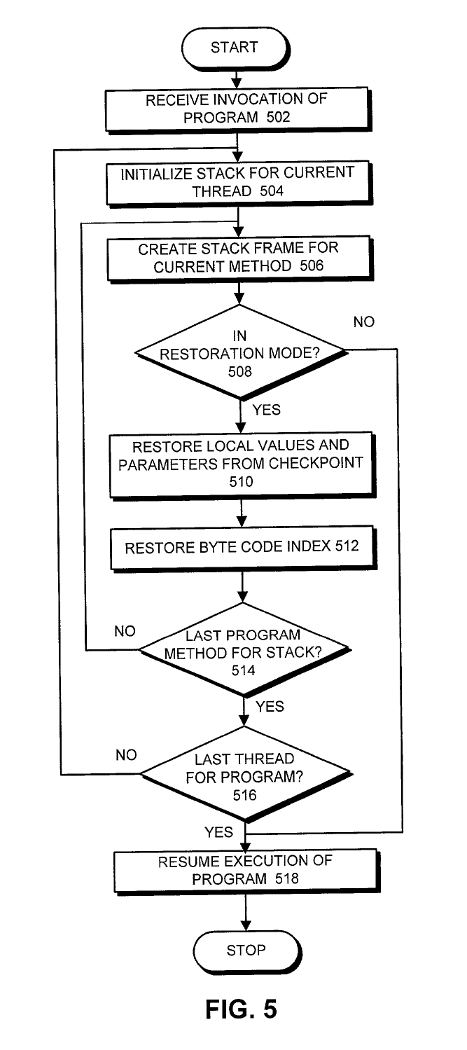

During operation, interpreter 208 reads checkpoint information 110 and creates thread stacks for each thread as described below with reference to FIG. 5. After establishing a thread stack, say thread stack 205, interpreter 208 creates stack frames for each thread stack as described below with reference to FIGS. 4 and 5. In the system shown, interpreter 208 creates thread stacks 205, 206, and 207, and restores stack frames 212-228 as shown. After restoring these thread stacks and stack frames, the program being executed by platform-independent virtual machine 204 has an equivalent state to the program that was being executed by platform-independent virtual machine 104 when checkpoint information 110 was saved. At this point, execution of the recovered program resumes. Note that platform-independent virtual machine 204 may be a different platform-independent virtual machine than platform-independent virtual machine 104. Moreover, computer system 202 may have a different architecture than computer system 102.

Interpreter 208

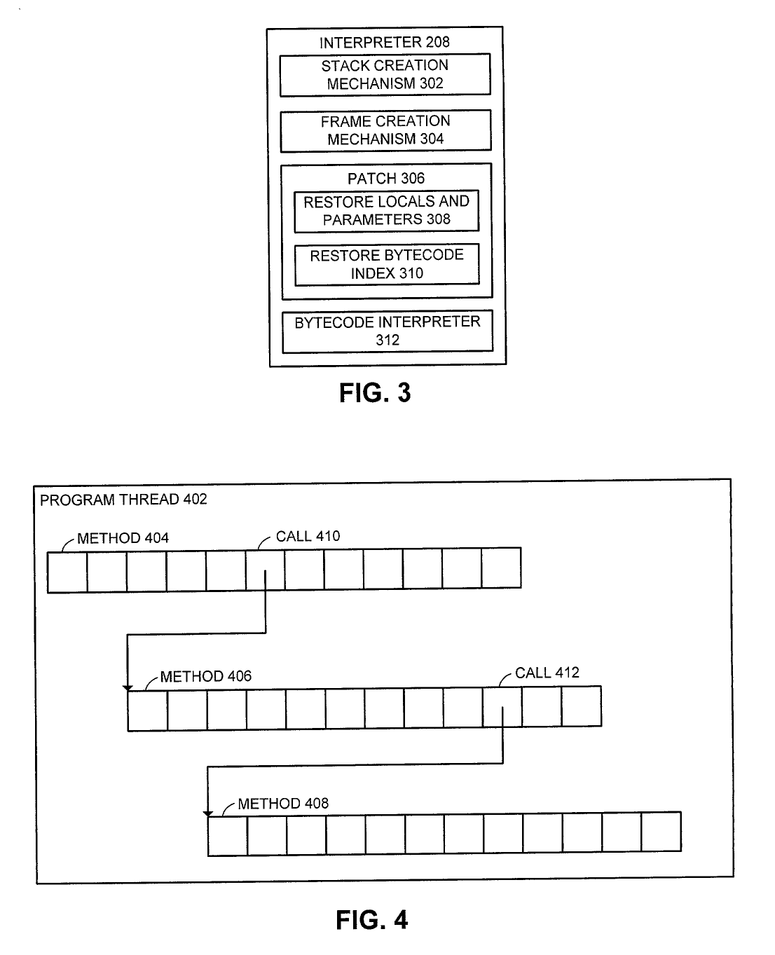

FIG. 3 illustrates the structure of interpreter 208 in accordance with an embodiment of the present invention. Interpreter 208 includes stack creation mechanism 302, frame creation mechanism 304, patch 306, and bytecode interpreter 312. Patch 306 includes a mechanism to restore locals and parameters 308 and a mechanism to restore the bytecode index. Stack creation mechanism 302, frame creation mechanism 304, and bytecode interpreter 312 are the typical elements of a platform-independent code interpreter, while patch 306 includes the additional elements used to recover from a checkpoint.

When interpreter 208 accepts a call to a new program method in a new thread, stack creation mechanism 302 creates a thread stack and then frame creation mechanism 304 creates a stack frame for the program method. The steps of creating the thread stack and the stack frame operate the same whether starting a new program or recovering from a checkpoint. After creating the stack frame, interpreter 208 determines whether a recovery from checkpoint is in progress. If not, execution continues normally using bytecode interpreter 312. However, if interpreter 208 is in recovery mode, indicating that a recovery from a checkpoint is in progress, control is passed to patch 306.

Patch 306 uses the facilities of interpreter 208 to restore the values for local variables and parameters from checkpoint information 110. This process may involve updating pointers to point to updated locations of the objects. Next, patch 306 restores the index of the next bytecode to be executed from checkpoint information 110. Restoring this index causes execution to resume at a bytecode within the method that was being executed when the checkpoint was created. Details of this operation are described below with reference to FIG. 4.

Restoring a Program Thread

FIG. 4 illustrates the state of program thread 402 in accordance with an embodiment of the present invention. Program thread 402 includes methods 404, 406, and 408. During normal operation, when method 404 starts, a stack frame is generated for method 404 on the thread stack associated with program thread 402. The bytecodes for method 404 execute using the variables and parameters on the thread stack. This execution continues until call 410 is reached. At call 410, execution of method 404 is suspended and a stack frame for method 406 is created. Next, method 406 begins executing. When call 412 is reached, execution of method 406 is suspended and a stack frame is generated for method 408. Next, method 408 executes until the end of method 408 is reached. At this point, method 408 returns control to method 406. This causes method 406 to resume execution following call 412 until the end of method 406 is reached. Method 406 then returns control to method 404. Method 404 then resumes executing the instructions after call 410.

When interpreter 208 is in recovery mode, however, the process is different. After method 404 starts and a stack frame is generated for method 404, patch 306 restores the values for the local variables and the parameters on the thread stack. This restoration process can involve updating pointers stored on the thread stack to point to updated locations for objects. After the values have been restored, patch 306 restores the bytecode index to call 410, thereby skipping the instructions at the beginning of method 404 up to call 410. This action of creating the stack frame and setting the bytecode index to the next call is repeated for methods 406 and 408. When program thread 402 has been recovered, execution of program thread 402 is suspended while other program threads in the program are recovered. After all program threads are recovered, execution for each thread is resumed.

Recovering a Checkpoint

FIG. 5 is a flowchart illustrating the process of recovering a program from a checkpoint in accordance with an embodiment of the present invention. The system starts when interpreter 208 receives an invocation of a program (step 502). Next, stack creation mechanism 302 creates a stack for the thread (step 504). After the thread stack has been created, frame creation mechanism 304 creates a stack frame for the method being executed (step 506).

Patch 306 then determines if interpreter 208 is executing in restoration mode (step 508). If so, patch 306 restores the values of the local variables and parameters within the stack frame from checkpoint information 110 (step 510). Next, patch 306 restores the bytecode index to point to the next bytecode to be executed (step 512). After the bytecode index has been set, patch 306 determines if the last nested method for the current stack has been restored (step 514). If not, control is returned to step 506 to continue restoring nested methods for this thread.

After all of the program methods for the thread have been restored, patch 306 determines if the last thread for the program has been restored (step 516). If not, the system returns to step 504 to continue restoring thread stacks. After all of the threads have been restored, or if interpreter 208 is not in restoration mode at step 508, bytecode interpreter 312 continues execution of the program (step 518).

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for implementing thread recovery from a checkpoint, comprising:
receiving an invocation of a program method at an interpreter;
determining if the interpreter is in restoration mode, wherein restoration mode facilitates recovery from the checkpoint using standard functions of the interpreter;
if the interpreter is in restoration mode, the method further comprises,
initializing a stack for a current thread,
creating a stack frame for the program method,
restoring local values in the stack frame from the checkpoint,
restoring parameters in the stack frame from the checkpoint, and
restoring a bytecode index for the method to identify a bytecode that is currently being executed within the method.

2. The method of claim 1, further comprising repeating the steps of:
creating the stack frame;
restoring local values;
restoring parameters; and
restoring the bytecode index;
for each nested method until the last nested method for the current thread is recovered.

3. The method of claim 2, further comprising repeating the steps of:
initiating an additional stack for a next thread;
creating the stack frame;
restoring local values;
restoring parameters; and
setting the bytecode index;
for each thread until a last thread for a current program is recovered.

4. The method of claim 3, further comprising delaying execution of the current thread until the last thread of the current program is recovered.

5. The method of claim 1, wherein restoring local values and restoring parameters involves adjusting pointer references to point to updated locations restored objects.

6. The method of claim 1, wherein the program method can be restored on computer architecture that is different from a computer architecture where the program method was originally executing.

7. A computer-readable storage medium storing instructions that when executed by a computer cause the computer to perform a method for implementing thread recovery from a checkpoint, the method comprising:
receiving an invocation of a program method at an interpreter;
determining if the interpreter is in restoration mode, wherein restoration mode facilitates recovery from the checkpoint using standard functions of the interpreter;
if the interpreter is in restoration mode, the method further comprises,
initializing a stack for a current thread,
creating a stack frame for the program method,
restoring local values in the stack frame from the checkpoint,
restoring parameters in the stack frame from the checkpoint, and
restoring a bytecode index for the method to identify a bytecode that is currently being executed within the method.

8. The computer-readable storage medium of claim 7, the method further comprising repeating the steps of:
creating the stack frame;
restoring local values;
restoring parameters; and
setting the bytecode index;
for each nested method until the last nested method for the current thread is recovered.

9. The computer-readable storage medium of claim 8, wherein the method further comprises repeating the steps of:
initiating an additional stack for a next thread;
creating the stack frame;
restoring local values;
restoring parameters; and
setting the bytecode index;
for each thread until a last thread for a current program is recovered.

10. The computer-readable storage medium of claim 9, wherein the method further comprises delaying execution of the current thread until the last thread of the current program is recovered.

11. The computer-readable storage medium of claim 7, wherein restoring local values and restoring parameters includes adjusting pointer references to point to updated locations for restored objects.

12. The computer-readable storage medium of claim 7, wherein the program method can be restored on computer architecture that is different from a computer architecture where the program method was originally executing.

13. An apparatus for implementing thread recovery from a checkpoint, comprising:
a receiving mechanism that is configured to receiving an invocation of a program method at an interpreter;
a determining mechanism that is configured to determine if the interpreter is in restoration mode, wherein restoration mode is a mode of the interpreter that allows recovery from the checkpoint using standard functions of the interpreter;
an initializing mechanism that is configured to initialize a stack for a current thread,
a creating mechanism that is configured to create a stack frame for the program method,
a restoring mechanism that is configured to restore local values in the stack frame from the checkpoint,
wherein the restoring mechanism is further configured to restore parameters in the stack frame from the checkpoint, and
wherein the restoring mechanism is configured to restore a bytecode index for the method to identify a bytecode that is currently being executed within the method.

14. The apparatus of claim 13, wherein the apparatus is configured to repeat the steps of:
creating the stack frame;
restoring local values;
restoring parameters; and
setting the bytecode index;
for each nested method until the last nested method for the current thread is recovered.

15. The apparatus of claim 14, wherein the apparatus is configured to repeat the steps of:
initiating an additional stack for a next thread;
creating the stack frame;
restoring local values;
restoring parameters; and
setting the bytecode index;
for each thread until a last thread for a current program is recovered.

16. The apparatus of claim 16, further comprising a delaying mechanism that is configured to delay execution of the current thread until the last thread of the current program is recovered.

17. The apparatus of claim 13, wherein the restoring mechanism is configured to adjust pointer references to point to updated locations for restored objects.

18. The apparatus of claim 13, wherein the program method can be restored on computer architecture that is different from a computer architecture where the program method was originally executing.
